(19) United States
(12) Patent Application Publication
(10) Pub. No.: US 2025/0296707 A1
(43) Pub. Date: Sep. 25, 2025

(54) SYSTEMS, APPARATUSES, METHODS, AND COMPUTER PROGRAM PRODUCTS FOR AIRCRAFT NAVIGATION AUGMENTATION

(71) Applicant: HONEYWELL INTERNATIONAL INC., Charlotte, NC (US)

(72) Inventors: Sreenivasan GOVINDILLAM, Bangalore (IN); Pradeep HUNCHA, Bangalore (IN); Apoorva RAO, Bangalore (IN)

(21) Appl. No.: 19/047,491

(22) Filed: Feb. 6, 2025

(30) Foreign Application Priority Data
Mar. 20, 2024 (IN) 202411021050

(51) Int. Cl. B64F 5/60; G07C 5/04

(52) U.S. Cl. CPC B64F 5/60; G07C 5/04

(57) ABSTRACT

Systems, apparatuses, methods, and computer program products are provided herein. For example, a method may include generating a vehicle navigation prediction model of a vehicle based at least in part on vehicle configuration data. In some embodiments, the method may include identifying vehicle operational data. In some embodiments, the vehicle operational data is representative of operations of the vehicle when the vehicle is operating. In some embodiments, the method may include generating, based at least in part on applying the vehicle operational data to the vehicle navigation prediction model, navigational performance prediction data. In some embodiments, the method may include initiating performance of one or more navigational prediction actions based at least in part on the navigational performance prediction data.

### CROSS-REFERENCE TO RELATED APPLICATIONS

This application claims the benefit of India Provisional Patent Application No. 202411021050, filed Mar. 20, 2024, the entire contents of which are incorporated by reference herein.

### TECHNOLOGICAL FIELD

Embodiments of the present disclosure relate generally to systems, apparatuses, methods, and computer program products for initiating performance of one or more navigational prediction actions.

### BACKGROUND

Applicant has identified many technical challenges and difficulties associated with systems, apparatuses, methods, and computer program products for augmenting the navigational capabilities of a vehicle. Through applied effort, ingenuity, and innovation, Applicant has provided one or more solutions for technical challenges and difficulties related to systems, apparatuses, methods, and computer program products for augmenting the navigational capabilities of a vehicle by developing solutions embodied in the present disclosure, which are described in detail below.

### BRIEF SUMMARY

Various embodiments described herein relate to systems, apparatuses, methods, and computer program products for initiating performance of one or more navigational prediction actions.

In accordance with one aspect of the disclosure, a method is provided. In some embodiments, the method may include generating a vehicle navigation prediction model of a vehicle based at least in part on vehicle configuration data. In some embodiments, the method may include identifying vehicle operational data. In some embodiments, the vehicle operational data is representative of operations of the vehicle when the vehicle is operating. In some embodiments, the method may include generating, based at least in part on applying the vehicle operational data to the vehicle navigation prediction model, navigational performance prediction data. In some embodiments, the method may include initiating performance of one or more navigational prediction actions based at least in part on the navigational performance prediction data.

In some embodiments, the method may include training the vehicle navigation prediction model based at least in part on vehicle navigation historical data.

In some embodiments, training the vehicle navigation prediction model occurs when the vehicle is offline.

In some embodiments, the vehicle is an aircraft.

In some embodiments, the vehicle navigation prediction model is generated by a mobile vehicle navigation support apparatus.

In some embodiments, the mobile vehicle navigation support apparatus is an electronic flight bag.

In some embodiments, the vehicle navigation prediction model is generated by an onboard vehicle navigation support apparatus.

In some embodiments, the vehicle navigation prediction model is generated by a remote vehicle navigation support apparatus.

In some embodiments, the vehicle navigation prediction model comprises a machine learning model.

In some embodiments, the vehicle operational data comprises avionics data and external data.

In some embodiments, the avionics data indicates that the vehicle is performing an aircraft approach sequence.

In some embodiments, initiating performance of one or more navigational prediction actions comprises generating a navigational prediction interface component.

In some embodiments, the navigational prediction interface comprises one or more predicted navigational adherence visualizations.

In some embodiments, each of the one or more predicted navigational adherence visualizations is associated with a corresponding physical location.

In accordance with another aspect of the disclosure, an apparatus is provided. In some embodiments, the apparatus may include at least one processor and at least one non-transitory memory including computer-coded instructions thereon. In some embodiments, the computer-coded instructions, with the at least one processor, cause the apparatus to generate a vehicle navigation prediction model of a vehicle based at least in part on vehicle configuration data. In some embodiments, the computer-coded instructions, with the at least one processor, cause the apparatus to identify vehicle operational data. In some embodiments, the vehicle operational data is representative of operations of the vehicle when the vehicle is operating. In some embodiments, the computer-coded instructions, with the at least one processor, cause the apparatus to generate, based at least in part on applying the vehicle operational data to the vehicle navigation prediction model, navigational performance prediction data. In some embodiments, the computer-coded instructions, with the at least one processor, cause the apparatus to initiate performance of one or more navigational prediction actions based at least in part on the navigational performance prediction data.

In some embodiments, the computer-coded instructions, with the at least one processor, cause the apparatus to train the vehicle navigation prediction model based at least in part on vehicle navigation historical data.

In some embodiments, training the vehicle navigation prediction model occurs when the vehicle is offline.

In some embodiments, the vehicle is an aircraft.

In some embodiments, the vehicle navigation prediction model is generated by a mobile vehicle navigation support apparatus.

In some embodiments, the mobile vehicle navigation support apparatus is an electronic flight bag.

In some embodiments, the vehicle navigation prediction model is generated by an onboard vehicle navigation support apparatus.

In some embodiments, the vehicle navigation prediction model is generated by a remote vehicle navigation support apparatus.

In some embodiments, the vehicle navigation prediction model comprises a machine learning model.

In some embodiments, the vehicle operational data comprises avionics data and external data.

In some embodiments, the avionics data indicates that the vehicle is performing an aircraft approach sequence.

In some embodiments, initiating performance of one or more navigational prediction actions comprises generating a navigational prediction interface component.

In some embodiments, the navigational prediction interface comprises one or more predicted navigational adherence visualizations.

In some embodiments, each of the one or more predicted navigational adherence visualizations is associated with a corresponding physical location.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for generating a vehicle navigation prediction model of a vehicle based at least in part on vehicle configuration data. In some embodiments, the computer program code, in execution with at least one processor, configures the computer program product for identifying vehicle operational data. In some embodiments, the vehicle operational data is representative of operations of the vehicle when the vehicle is operating. In some embodiments, the computer program code, in execution with at least one processor, configures the computer program product for generating, based at least in part on applying the vehicle operational data to the vehicle navigation prediction model, navigational performance prediction data. In some embodiments, the computer program code, in execution with at least one processor, configures the computer program product for initiating performance of one or more navigational prediction actions based at least in part on the navigational performance prediction data.

In some embodiments, the computer program code, in execution with at least one processor, configures the computer program product for training the vehicle navigation prediction model based at least in part on vehicle navigation historical data.

In some embodiments, training the vehicle navigation prediction model occurs when the vehicle is offline.

In some embodiments, the vehicle is an aircraft.

In some embodiments, the vehicle navigation prediction model is generated by a mobile vehicle navigation support apparatus.

In some embodiments, the mobile vehicle navigation support apparatus is an electronic flight bag.

In some embodiments, the vehicle navigation prediction model is generated by an onboard vehicle navigation support apparatus.

In some embodiments, the vehicle navigation prediction model is generated by a remote vehicle navigation support apparatus.

In some embodiments, the vehicle navigation prediction model comprises a machine learning model.

In some embodiments, the vehicle operational data comprises avionics data and external data.

In some embodiments, the avionics data indicates that the vehicle is performing an aircraft approach sequence.

In some embodiments, initiating performance of one or more navigational prediction actions comprises generating a navigational prediction interface component.

In some embodiments, the navigational prediction interface comprises one or more predicted navigational adherence visualizations.

In some embodiments, each of the one or more predicted navigational adherence visualizations is associated with a corresponding physical location.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of an example apparatus that may be specially configured in accordance with an example embodiment of the present disclosure;

FIG. 3 illustrates an example visualization of a navigational prediction interface component in accordance with one or more embodiments of the present disclosure;

FIG. 4 illustrates another example visualization of a navigational prediction interface component in accordance with one or more embodiments of the present disclosure; and

FIG. 5 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with systems, apparatuses, methods, and computer program products for augmenting the navigational capabilities of a vehicle. As would be understood by one skilled in the field to which this disclosure pertains, there are numerous example scenarios in which a user may use systems, apparatuses, methods, and computer program products for augmenting the navigational capabilities of a vehicle.

In many applications, systems, apparatuses, methods, and computer program products for augmenting the navigational capabilities of a vehicle are desirable. For example, it may be desirable to augment the navigational capabilities of an aircraft. In this way, for example, it may be possible to prevent a vehicle from violating the vehicle's required navigational performance (e.g., prevent an aircraft from violating its allocated flight area).

Example solutions for augmenting the navigational capabilities of a vehicle, such as an aircraft, include monitoring the position of the vehicle using one or more sensors (e.g., a global positioning system (GPS) sensor) to determine if the vehicle is adhering to the vehicle's required navigational performance. In such example solutions, if the vehicle violates from the vehicle's required navigational performance, an alert and/or message may be generated informing the operator of the vehicle of the violation. However, such example solutions are often inaccurate and reactive, which reduces the effectiveness of such example solutions. For example, such example solutions are reactive in that augmentation to the vehicle's navigation only occurs after the vehicle has violated the vehicle's required navigational performance (e.g., such example solutions are unable to predict potential navigational violations and are only able to react to navigational violations). As another example, such example solutions are unable to determine when sensors are malfunctioning and, as such, may provide inaccurate navigational augmentation. As another example, such example solutions are unable to proactively initiate performance of actions that mitigate or resolve navigational violations. As such, there is a desire for systems, apparatuses, methods, and computer program products for initiating performance of one or more navigational prediction actions so that vehicle navigational augmentation can be provided in a predictive and accurate manner.

Thus, to address these and/or other issues related to systems, apparatuses, methods, and computer program products for initiating performance of one or more navigational prediction actions, example systems, apparatuses, methods, and computer program product for initiating performance of one or more navigational prediction actions are disclosed herein. For example, an embodiment in this disclosure, described in greater detail below, includes a method that includes generating a vehicle navigation prediction model of a vehicle based at least in part on vehicle configuration data. In some embodiments, the method includes identifying vehicle operational data. In some embodiments, the vehicle operational data is representative of operations of the vehicle when the vehicle is operating. In some embodiments, the method includes generating, based at least in part on applying the vehicle operational data to the vehicle navigation prediction model, navigational performance prediction data. In some embodiments, the method includes initiating performance of one or more navigational prediction actions based at least in part on the navigational performance prediction data. Accordingly, the example systems, apparatuses, computer program products, and/or methods provided herein enable the accurate and predictive augmentation of vehicle navigation capabilities.

### Example Systems and Apparatuses

Embodiments of the present disclosure herein include systems, apparatuses, methods, and computer program products configured for initiating performance of one or more navigational prediction actions. It should be readily appreciated that the embodiments of the apparatus, systems, methods, and computer program product described herein may be configured in various additional and alternative manners in addition to those expressly described herein.

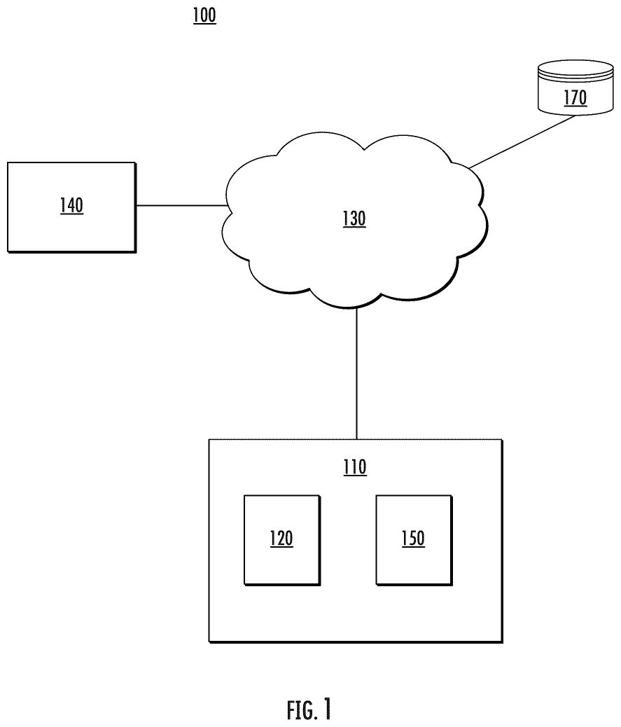

FIG. 1 illustrates an example block diagram of an environment 100 in which embodiments of the present disclosure may operate. Specifically, FIG. 1 illustrates a vehicle 110. In some embodiments, a vehicle may describe any machine, robot, computing devices, and/or apparatus comprised of hardware, software, firmware, and/or any combination thereof, that maneuvers throughout an environment through any medium. In some contexts, a vehicle is utilized to transport objects, entities (e.g., people, animals, or other beings), or other onboard cargo. In some situations, a vehicle may be transporting no object except for the vehicle itself. Vehicles may be used for transportation on land, in water, in air, or across any other medium. Examples of vehicles include airplanes, helicopters, drones, cars, trucks, submarines, boats, and/or the like. Vehicles are not limited to the examples listed herein and may include any type of transportation device.

In some embodiments, the vehicle 110 may include any number of individual components. The components of the vehicle 110 may perform a particular function during operation of the vehicle 110. For example, the components may include one or more multi-function control and display unit (MCDU) components, flight management system (FMS) components, sensor components, actuator components, primary flight display (PFD) components, navigation components (e.g., inertial reference system (IRS) components, global positioning system (GPS) components, and/or the like), radio components (e.g., global positioning system (GPS) radio components), and/or the like. In this regard, for example, the individual components of the vehicle 110 may include components associated with a particular process or operation performed by the vehicle 110.

In some embodiments, each individual component of the vehicle 110 is associated with a determinable location. The determinable location of a particular component in some embodiments represents an absolute position (e.g., GPS coordinates, latitude, and longitude locations, and/or the like) or a relative position (e.g., a point representation of the location of a component from a local origin point corresponding to the vehicle 110). In some embodiments, a component includes or otherwise is associated with a location sensor and/or software-driven location services that provide the location data representing the location corresponding to that component. In other embodiments the location of a component is stored and/or otherwise predetermined within a software environment, provided by a user and/or otherwise determinable to one or more systems.

Additionally, or alternatively, in some embodiments, the vehicle 110 itself is associated with a determinable location. The determinable location of the vehicle 110 in some embodiments represents an absolute position (e.g., GPS coordinates, latitude and longitude locations, an address, and/or the like) or a relative position of the vehicle 110 (e.g., an identifier representing the location of the vehicle 110 as compared to one or more other vehicles, one or more buildings (e.g., an airport), an enterprise headquarters, or general description in the world for example based at least in part on continent, state, or other definable region). In some embodiments, the vehicle 110 includes or otherwise is associated with a location sensor and/or software-driven location services that provide the location data corresponding to the vehicle 110. In other embodiments, the location of the vehicle 110 is stored and/or otherwise determinable to one or more systems.

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

In some embodiments, the environment 100 may include a vehicle navigation support apparatus. In some embodiments, the vehicle navigation support apparatus may be at least partially embodied as a mobile vehicle navigation support apparatus 120. Additionally, or alternatively, the vehicle navigation support apparatus may be at least partially embodied as an onboard vehicle navigation support apparatus 150. Additionally, or alternatively, the vehicle navigation support apparatus may be at least partially embodied as a remote vehicle navigation support apparatus 140.

In some embodiments, for example, the vehicle navigation support apparatus (e.g., the mobile vehicle navigation support apparatus 120, the onboard vehicle navigation support apparatus 150, and/or the remote vehicle navigation support apparatus 140) may be configured to initiate performance of one or more navigational prediction actions. The vehicle navigation support apparatus may be electronically and/or communicatively coupled to the vehicle 110, individual components of the vehicle 110, and/or one or more databases 170. The vehicle navigation support apparatus may be located remotely (e.g., in a control tower at an airport), in proximity of (e.g., in an electronic flight bag associated with the vehicle 110), and/or within the vehicle 110 (e.g., as an onboard component of the vehicle 110). In some embodiments, the vehicle navigation support apparatus is configured via hardware, software, firmware, and/or a combination thereof, to perform data intake of one or more types of data associated with one or more of the vehicle 110. Additionally, or alternatively, in some embodiments, the vehicle navigation support apparatus is configured via hardware, software, firmware, and/or a combination thereof, to generate and/or transmit command(s) that control, adjust, or otherwise impact operations of one or more of the vehicle 110 or specific component(s) thereof, for example for controlling one or more operations of the vehicle 110. Additionally or alternatively still, in some embodiments, the vehicle navigation support apparatus is configured via hardware, software, firmware, and/or a combination thereof, to perform data reporting and/or other data output process(es) associated with monitoring or otherwise analyzing operations of one or more of the vehicle 110 or specific component(s) thereof, for example for generating and/or outputting report(s) corresponding to the operations performed via the vehicle 110. For example, in various embodiments, the vehicle navigation support apparatus may be configured to execute and/or perform one or more operations and/or functions described herein.

The one or more databases 170 may be configured to receive, store, and/or transmit data. In some embodiments, the one or more databases 170 may be associated with vehicle configuration data, vehicle operational data, navigational performance prediction data, vehicle navigation historical data, avionics data, and/or external data.

In some embodiments, the vehicle configuration data, vehicle operational data, navigational performance prediction data, vehicle navigation historical data, avionics data, and/or external data may be received from the vehicle 110. In this regard, for example, the vehicle 110 may have one or more sensors that capture vehicle configuration data, vehicle operational data, navigational performance prediction data, vehicle navigation historical data, avionics data, and/or external data and/or one or more datastores that store vehicle configuration data, vehicle operational data, navigational performance prediction data, vehicle navigation historical data, avionics data, and/or external data. In some embodiments, the vehicle configuration data, vehicle operational data, navigational performance prediction data, vehicle navigation historical data, avionics data, and/or external data may be received from the vehicle navigation support apparatus. In this regard, for example, the vehicle navigation support apparatus may be configured to identify vehicle configuration data, vehicle operational data, navigational performance prediction data, vehicle navigation historical data, avionics data, and/or external data associated with the vehicle 110.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the vehicle navigation support apparatus may include the one or more databases 170, which may collectively be located in or at the vehicle 110.

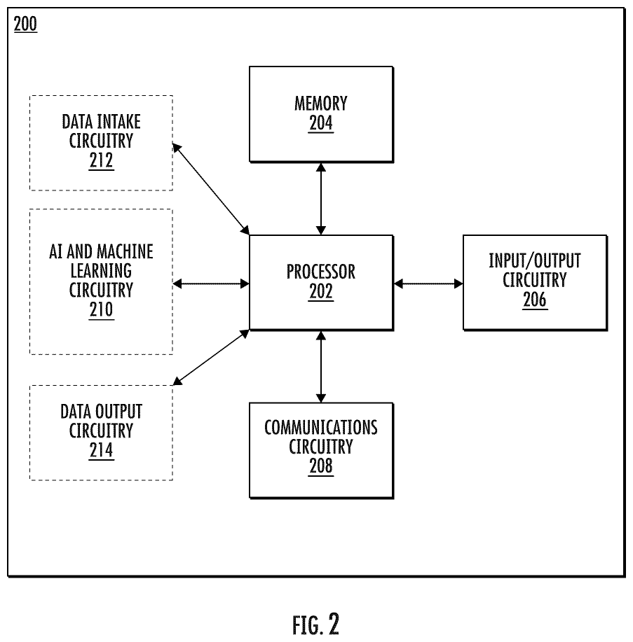

FIG. 2 illustrates an example block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. For example, the computing apparatus 200 may be embodied as one or more of a specifically configured personal computing apparatus, a specifically configured cloud-based computing apparatus, a specifically configured embedded computing device (e.g., configured for edge computing, and/or the like). Examples of an apparatus 200 may include, but is not limited to, vehicle navigation support apparatus (e.g., the mobile vehicle navigation support apparatus 120, the onboard vehicle navigation support apparatus 150, and/or the remote vehicle navigation support apparatus 140), the one or more databases 170, and/or the vehicle 110. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 200 of vehicle navigation support apparatus (e.g., the mobile vehicle navigation support apparatus 120, the onboard vehicle navigation support apparatus 150, and/or the remote vehicle navigation support apparatus 140) may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuitry 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally, or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the vehicle 110. In some embodiments, the data intake circuitry 212 includes hardware, software, firmware, and/or a combination thereof, that communicates with one or more sensor(s) component(s), and/or the like within the vehicle 110 to receive particular data associated with such operations of the vehicle 110. Additionally, or alternatively, in some embodiments, the data intake circuitry 212 includes hardware, software, firmware, and/or a combination thereof, that retrieves particular data associated with the vehicle 110 from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally, or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect to the AI and machine learning circuitry 210.

With reference to FIGS. 1-4, in some embodiments, the vehicle navigation support apparatus (e.g., the mobile vehicle navigation support apparatus 120, the onboard vehicle navigation support apparatus 150, and/or the remote vehicle navigation support apparatus 140) may be configured to identify vehicle configuration data. In some embodiments, vehicle configuration data may be one or more items of data representative of a physical layout, electrical layout, and/or control layout of the vehicle 110. In this regard, when the vehicle 110 is an aircraft, the vehicle configuration data may be one or more items of data representative of a physical layout, electrical layout, and/or control layout of an aircraft. In some embodiments, identifying the vehicle configuration data may include the vehicle navigation support apparatus (e.g., the mobile vehicle navigation support apparatus 120, the onboard vehicle navigation support apparatus 150, and/or the remote vehicle navigation support apparatus 140) being configured to extract the vehicle configuration data from a specification associated with the vehicle 110 (e.g., an aircraft specification).

In some embodiments, the vehicle navigation support apparatus (e.g., the mobile vehicle navigation support apparatus 120, the onboard vehicle navigation support apparatus 150, and/or the remote vehicle navigation support apparatus 140) may be configured to generate a vehicle navigation prediction model (e.g., a vehicle navigation accuracy prediction model). In some embodiments, the vehicle navigation prediction model may be of the vehicle 110 (e.g., the vehicle navigation prediction model may be a model of at least a portion of the vehicle 110). In some embodiments, the vehicle navigation prediction model may be based at least in part on vehicle configuration data (e.g., vehicle configuration data of the vehicle 110 identified by the vehicle navigation support apparatus).

In some embodiments, the vehicle navigation prediction model may be a data entity that describes parameters, hyper-parameters, and/or defined operations of a rules-based, machine learning model, and/or generative artificial intelligence model (e.g., a model including at least one of one or more rule-based layers, one or more layers that depend on trained parameters, coefficients, and/or the like). The vehicle navigation prediction model may utilize one or more of any type of machine learning, rules-based, and/or artificial intelligence techniques including one or more of supervised learning, unsupervised learning, semi-supervised learning, reinforcement learning, computer vision techniques, sequence modeling techniques, language processing techniques, neural network techniques, and/or generative artificial intelligence techniques.

Additionally, or alternatively, the vehicle navigation prediction model may be a computer model representation of the vehicle 110 based at least in part on the vehicle configuration data. In this regard, for example, the vehicle navigation prediction model may include one or more computer model representations of one or more of the individual components of the vehicle 110. For example, the vehicle navigation prediction model may include one or more computer model representations of one or more multi-function control and display unit (MCDU) components, flight management system (FMS) components, sensor components, actuator components, primary flight display (PFD) components, navigation components (e.g., inertial reference system (IRS) components, global positioning system (GPS) components, and/or the like), radio components (e.g., global positioning system (GPS) radio components), and/or the like.

In some embodiments, the vehicle navigation prediction model of the vehicle 110 may be generated by the mobile vehicle navigation support apparatus 120 (e.g., when the vehicle navigation support apparatus is the mobile vehicle navigation support apparatus 120). In this regard, the vehicle navigation prediction model of the vehicle 110 may be stored in the mobile vehicle navigation support apparatus 120. In this regard, the vehicle navigation prediction model of the vehicle 110 may be generated and/or stored by an electronic flight bag (e.g., when the mobile vehicle navigation support apparatus 120 is an electronic flight bag).

In some embodiments, the vehicle navigation prediction model may be generated by the onboard vehicle navigation support apparatus 150 (e.g., when the vehicle navigation support apparatus is the onboard vehicle navigation support apparatus 150). In this regard, the vehicle navigation prediction model may be stored in the onboard vehicle navigation support apparatus 150. In some embodiments, the vehicle navigation prediction model may be generated by the remote vehicle navigation support apparatus 140 (e.g., when the vehicle navigation support apparatus is the remote vehicle navigation support apparatus 140). In this regard, the vehicle navigation prediction model may be stored in the remote vehicle navigation support apparatus 140.

In some embodiments, the vehicle navigation support apparatus (e.g., the mobile vehicle navigation support apparatus 120, the onboard vehicle navigation support apparatus 150, and/or the remote vehicle navigation support apparatus 140) may be configured to identify vehicle operational data. In some embodiments, vehicle operational data may be representative of operations of the vehicle 110 when the vehicle 110 is operating. In some embodiments, for example, the vehicle 110 may be operating when the vehicle is taxiing, in flight (e.g., an aircraft cruising at altitude), during an aircraft approach sequence, taking off, driving down a highway, and/or the like.

In some embodiments, the vehicle navigation support apparatus (e.g., the mobile vehicle navigation support apparatus 120, the onboard vehicle navigation support apparatus 150, and/or the remote vehicle navigation support apparatus 140) may be configured to identify vehicle operational data by capturing it from one or more of the components of the vehicle 110. In this regard, for example, the vehicle navigation support apparatus (e.g., the mobile vehicle navigation support apparatus 120, the onboard vehicle navigation support apparatus 150, and/or the remote vehicle navigation support apparatus 140) may be configured to capture vehicle operational data from one or more of one or more multi-function control and display unit (MCDU) components, flight management system (FMS) components, sensor components, actuator components, primary flight display (PFD) components, navigation components (e.g., inertial reference system (IRS) components, global positioning system (GPS) components, and/or the like), radio components (e.g., global positioning system (GPS) radio components), and/or the like.

In some embodiments, the vehicle operational data may include avionics data. In some embodiments, the avionics data may be one or more items of data representative of the avionics of the vehicle 110. In this regard, for example, the avionics data may include one or more items of data representative of an aircraft approach sequence of the vehicle 110 (e.g., when the vehicle 110 is an aircraft, an aircraft approach sequence that the aircraft is performing to land the aircraft at an airport). As another example, the avionics data may include one or more items of data representative of a required navigational performance (RNP) of the vehicle 110. As another example, the avionics data may include one or more items of data representative of predictive receiver autonomous integrity monitoring (PRAIM). As another example, the avionics data may include one or more items of data representative of one or more sensor faults associated with the vehicle 110 (e.g., with one or more of the one or more sensor components of the vehicle 110). As another example, the avionics data may include one or more items of data representative of one or more selected sensors associated with the vehicle 110 (e.g., one or more selected sensors of the one or more sensor components of the vehicle 110). As another example, the avionics data may include one or more items of data representative of sensor drift of one or more of the one or more sensor components of the vehicle 110. As another example, the avionics data may include one or more items of data representative of sensor stability of one or more of the one or more sensor components of the vehicle 110 (e.g., data representative of data (e.g., position data) provided by a sensor compared to previous data (e.g., previous position data) provided by the sensor).

In some embodiments, the avionics data may be provided, captured, and/or generated at least in part by an operator of the vehicle 110 (e.g., a pilot). Additionally, or alternatively, avionics data may be provided, captured, and/or generated at least in part by another individual associated with the vehicle 110 (e.g., an air traffic controller). Additionally, or alternatively, the avionics data may be provided, captured, and/or generated at least in part by one or more components of the vehicle 110. In this regard, for example, the avionics data may be provided, captured, and/or generated at least in part by one or more of one or more multi-function control and display unit (MCDU) components, flight management system (FMS) components, sensor components, actuator components, primary flight display (PFD) components, navigation components (e.g., inertial reference system (IRS) components, global positioning system (GPS) components, and/or the like), radio components (e.g., global positioning system (GPS) radio components), and/or the like.

In some embodiments, the vehicle operational data may include external data. In some embodiments, the external data may be one or more items of data representative of external factors that may impact the vehicle 110. In this regard, for example, the external data may include one or more items of data representative of information associated with a global navigation satellite system (GNSS) (e.g., global positioning system (GPS) coordinates). As another example, the external data may include one or more items of data representative of information associated with a notice to air missions (NOTAM). As another example, the external data may include one or more items of data representative of information associated with a non-directional radio beacon (NDB). As another example, the external data may include one or more items of data representative of weather information for areas proximate to the vehicle 110 (e.g., a thunderstorm is present at an airport where the vehicle 110 intends to perform an aircraft approach sequence to land at).

In some embodiments, the external data may be provided, captured, and/or generated at least in part by one or more external systems (e.g., a system external to the vehicle 110). For example, the external data may be provided, captured, and/or generated at least in part by a global positioning system (GPS). As another example, the external data may be provided, captured, and/or generated at least in part by an aviation authority (e.g., the Federal Aviation Administration (FAA)). As another example, the external data may be provided, captured, and/or generated at least in part by one or more other vehicles (e.g., an aircraft in proximity to the vehicle 110).

In some embodiments, the vehicle navigation support apparatus (e.g., the mobile vehicle navigation support apparatus 120, the onboard vehicle navigation support apparatus 150, and/or the remote vehicle navigation support apparatus 140) may be configured to generate navigational performance prediction data. In some embodiments, the vehicle navigation support apparatus (e.g., the mobile vehicle navigation support apparatus 120, the onboard vehicle navigation support apparatus 150, and/or the remote vehicle navigation support apparatus 140) may be configured to generate navigational performance prediction data at least in part by applying vehicle operational data to the vehicle navigation prediction model.

In some embodiments, navigational performance prediction data may be one or more items of data representative of a predicted navigational pathway of the vehicle 110. In this regard, a predicted navigational pathway of the vehicle 110 may include a predicted pathway that the vehicle 110 may take based at least in part on the current operation of the vehicle 110 (e.g., based at least in part on the avionics data and/or the external data as applied to the vehicle navigation prediction model). For example, a predicted navigational pathway of the vehicle 110 may be a predicted pathway that the vehicle 110 may take during the final portion of an aircraft approach sequence.

In some embodiments, the navigational performance prediction data may be one or more items of data representative of a predicted navigational adherence of the vehicle 110. In this regard, a predicted navigational adherence of the vehicle 110 may include a prediction of whether the vehicle 110 will adhere to a desired or selected pathway (e.g., based at least in part on the avionics data and/or the external data as applied to the vehicle navigation prediction model). For example, a predicted navigational adherence of the vehicle 110 may be a prediction of whether the vehicle 110 will be within a particular altitude range at a particular point in an aircraft approach sequence. Additionally, or alternatively, a predicted navigational adherence of the vehicle 110 may be a prediction of whether the vehicle 110 will adhere to a required navigational performance (RNP).

In some embodiments, the navigational performance prediction data may be one or more items of data representative of a sensor fault associated with the vehicle 110. In this regard, the navigational performance prediction data may include an indication whether one or more of the one or more sensor components of the vehicle 110 is affected by a fault and/or is predicted to be affected by a fault (e.g., based at least in part on the avionics data and/or the external data as applied to the vehicle navigation prediction model). For example, the navigational performance prediction data may include an indication that a global positioning system (GPS) sensor component of the vehicle 110 is affected by a fault and/or is predicted to be affected by a fault and, in some embodiments, that the operator of the vehicle 110 should not rely on global positioning system (GPS) coordinates that the vehicle 110 is providing to the operator of the vehicle 110.

In some embodiments, the navigational performance prediction data may be one or more items of data representative of a predicted weather forecast associated with the vehicle 110. In this regard, the navigational performance prediction data may include an indication of a weather forecast in an area where the vehicle is transiting towards that may impact the navigation of the vehicle 110. For example, the navigational performance prediction data may include an indication of a weather forecast at an airport where the vehicle 110 intends to perform an aircraft approach sequence.

In some embodiments, the vehicle navigation support apparatus (e.g., the mobile vehicle navigation support apparatus 120, the onboard vehicle navigation support apparatus 150, and/or the remote vehicle navigation support apparatus 140) may be configured to initiate performance of one or more navigational prediction actions. In some embodiments, the vehicle navigation support apparatus (e.g., the mobile vehicle navigation support apparatus 120, the onboard vehicle navigation support apparatus 150, and/or the remote vehicle navigation support apparatus 140) may be configured to initiate performance of one or more navigational prediction actions based at least in part on the navigational performance prediction data.

In some embodiments, a navigational prediction action may include generating and/or transmitting an alert and/or message based at least in part on the navigational performance prediction data. In this regard, in some embodiments, the vehicle navigation support apparatus (e.g., the mobile vehicle navigation support apparatus 120, the onboard vehicle navigation support apparatus 150, and/or the remote vehicle navigation support apparatus 140) may be configured to initiate performance of one or more navigational prediction actions by generating an alert and/or message for and/or transmitting an alert and/or message to an operator of the vehicle (e.g., a pilot) based at least in part on the navigational performance prediction data. For example, the vehicle navigation support apparatus (e.g., the mobile vehicle navigation support apparatus 120, the onboard vehicle navigation support apparatus 150, and/or the remote vehicle navigation support apparatus 140) may be configured to initiate performance of one or more navigational prediction actions by generating an alert and/or message for and/or transmitting an alert and/or message to an operator of the vehicle 110 that indicates that vehicle 110 will not be able to perform its intended aircraft approach sequence (e.g., the navigational performance prediction data indicates that it will be impossible for the vehicle to adhere to the required navigational performance (RNP) for the intended aircraft approach sequence).

In some embodiments, vehicle navigation support apparatus (e.g., the mobile vehicle navigation support apparatus 120, the onboard vehicle navigation support apparatus 150, and/or the remote vehicle navigation support apparatus 140) may be configured to initiate performance of one or more navigational prediction actions by generating an alert and/or message for and/or transmitting an alert and/or message to another individual associated with the vehicle 110 (e.g., an air traffic controller) based at least in part on the navigational performance prediction data. For example, the vehicle navigation support apparatus (e.g., the mobile vehicle navigation support apparatus 120, the onboard vehicle navigation support apparatus 150, and/or the remote vehicle navigation support apparatus 140) may be configured to initiate performance of one or more navigational prediction actions by generating an alert and/or message for and/or transmitting an alert and/or message to another individual associated with the vehicle 110 that indicates that vehicle 110 will not be able to perform its intended aircraft approach sequence (e.g., the navigational performance prediction data indicates that it will be impossible for the vehicle to adhere to the required navigational performance (RNP) for the intended aircraft approach sequence and, in some embodiments, that the vehicle 110 should perform a go around). In this regard, another individual associated with the vehicle 110 may make adjustments based at least in part on the alert and/or message (e.g., schedule another aircraft for a particular landing slot at an airport if the vehicle 110 performs a go around).

In some embodiments, vehicle navigation support apparatus (e.g., the mobile vehicle navigation support apparatus 120, the onboard vehicle navigation support apparatus 150, and/or the remote vehicle navigation support apparatus 140) may be configured to initiate performance of one or more navigational prediction actions by generating an alert and/or message for and/or transmitting an alert and/or message to a maintenance system associated with the vehicle 110 based at least in part on the navigational performance prediction data. For example, the vehicle navigation support apparatus (e.g., the mobile vehicle navigation support apparatus 120, the onboard vehicle navigation support apparatus 150, and/or the remote vehicle navigation support apparatus 140) may be configured to initiate performance of one or more navigational prediction actions by generating an alert and/or message for and/or transmitting an alert and/or message to a maintenance system associated with the vehicle 110 that indicates that vehicle 110 is affected by a sensor fault and, in some embodiments, that a sensor component of the vehicle 110 needs to be replaced after the vehicle 110 completes an aircraft approach sequence.

In some embodiments, a navigational prediction action may include causing actuation of a component of the vehicle 110 based at least in part on the navigational performance prediction data. For example, if the vehicle 110 is affected by a sensor fault, the vehicle navigation support apparatus (e.g., the mobile vehicle navigation support apparatus 120, the onboard vehicle navigation support apparatus 150, and/or the remote vehicle navigation support apparatus 140) may be configured to initiate performance of one or more navigational prediction actions by causing actuation of a sensor component of the vehicle 110 such that the sensor component is reset. As another example, if a predicted navigational pathway of the vehicle 110 indicates that the vehicle will not adhere to the required navigational performance of the vehicle 110, the vehicle navigation support apparatus (e.g., the mobile vehicle navigation support apparatus 120, the onboard vehicle navigation support apparatus 150, and/or the remote vehicle navigation support apparatus 140) may be configured to initiate performance of one or more navigational prediction actions by causing actuation of a flight management system (FMS) component of the vehicle 110 such that the heading of the vehicle 110 is adjusted.

In some embodiments, a navigational prediction action may include generating one or more navigational prediction interface components. In this regard, the vehicle navigation support apparatus (e.g., the mobile vehicle navigation support apparatus 120, the onboard vehicle navigation support apparatus 150, and/or the remote vehicle navigation support apparatus 140) may be configured to initiate performance of one or more navigational prediction actions by generating one or more navigational prediction interface components.

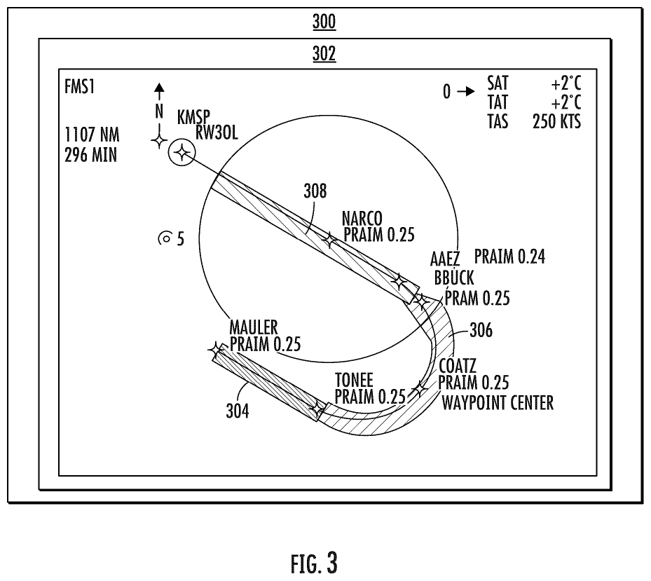

In some embodiments, for example and as illustrated in FIG. 3, the vehicle navigation support apparatus (e.g., the mobile vehicle navigation support apparatus 120, the onboard vehicle navigation support apparatus 150, and/or the remote vehicle navigation support apparatus 140) may be configured to initiate performance of one or more navigational prediction actions by generating a first navigational prediction interface component 302. In some embodiments, the first navigational prediction interface component 302 may include one or more first predicted navigational adherence visualizations. For example, the first navigational prediction interface component 302 may include an adequate navigational adherence visualization 304, a marginal navigational adherence visualization 306, and/or a violation navigational adherence visualization 308. In some embodiments, each of the first predicted navigational adherence visualizations may be represented graphically, by shading, by color, by text, by numbers, and/or the like. In some embodiments, the vehicle navigation support apparatus (e.g., the mobile vehicle navigation support apparatus 120, the onboard vehicle navigation support apparatus 150, and/or the remote vehicle navigation support apparatus 140) may be configured to cause the first navigational prediction interface component 302 to be rendered on a first navigational interface 300.

In some embodiments, each of the one or more first predicted navigational adherence visualizations may be associated with a corresponding physical location. For example, the adequate navigational adherence visualization 304 may be associated with a first physical location. As another example, the marginal navigational adherence visualization 306 may be associated with a second physical location. As another example, the violation navigational adherence visualization 308 may be associated with a third physical location.

In some embodiments, each of the one or more first predicted navigational adherence visualizations may be associated with a corresponding predicted navigational adherence. In this regard, for example, the adequate navigational adherence visualization 304 may be associated with an adequate predicted navigational adherence (e.g., the vehicle 110 will adhere to a required navigational performance (RNP) when the vehicle 110 is located in the physical location corresponding to the adequate navigational adherence visualization 304). As another example, the marginal navigational adherence visualization 306 may be associated with a marginal predicted navigational adherence (e.g., it is marginal that the vehicle 110 will adhere to a required navigational performance (RNP) when the vehicle 110 is located in the physical location corresponding to the marginal navigational adherence visualization 306). As another example, the violation navigational adherence visualization 308 may be associated with a violation predicted navigational adherence (e.g., the vehicle 110 will not adhere to a required navigational performance (RNP) when the vehicle 110 is located in the physical location corresponding to the violation navigational adherence visualization 308).

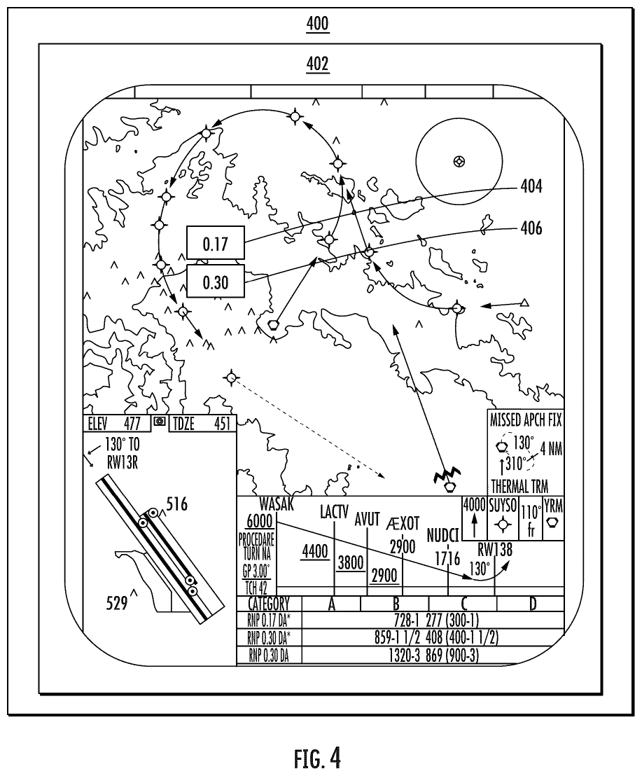

In some embodiments, for example and as illustrated in FIG. 4, the vehicle navigation support apparatus (e.g., the mobile vehicle navigation support apparatus 120, the onboard vehicle navigation support apparatus 150, and/or the remote vehicle navigation support apparatus 140) may be configured to initiate performance of one or more navigational prediction actions by generating a second navigational prediction interface component 402. In some embodiments, the second navigational prediction interface component 402 may include one or more second predicted navigational adherence visualizations. For example, the second navigational prediction interface component 402 may include an acceptable navigational adherence visualization 404 and/or an unacceptable navigational adherence visualization 406. In some embodiments, each of the second predicted navigational adherence visualizations may be represented graphically, by shading, by color, by text, by numbers, and/or the like. In some embodiments, the vehicle navigation support apparatus (e.g., the mobile vehicle navigation support apparatus 120, the onboard vehicle navigation support apparatus 150, and/or the remote vehicle navigation support apparatus 140) may be configured to cause the second navigational prediction interface component 402 to be rendered on a second navigational interface 400.

In some embodiments, each of the one or more second predicted navigational adherence visualizations may be associated with a corresponding predicted navigational adherence. In this regard, for example, the acceptable navigational adherence visualization 404 may be associated with an acceptable predicted navigational adherence (e.g., the vehicle 110 will be able to adhere to a particular required navigational performance (RNP)). As another example, the unacceptable navigational adherence visualization 406 may be associated with an unacceptable predicted navigational adherence (e.g., the vehicle 110 will not be able to adhere to a particular required navigational performance (RNP)).

In some embodiments, the vehicle navigation support apparatus (e.g., the mobile vehicle navigation support apparatus 120, the onboard vehicle navigation support apparatus 150, and/or the remote vehicle navigation support apparatus 140) may be configured to train the vehicle navigation prediction model. In some embodiments, the vehicle navigation support apparatus (e.g., the mobile vehicle navigation support apparatus 120, the onboard vehicle navigation support apparatus 150, and/or the remote vehicle navigation support apparatus 140) may be configured to train the vehicle navigation prediction model based at least in part on vehicle navigation historical data.

In some embodiments, vehicle navigation historical data may be one or more items of data representative of historical vehicle operational data. In this regard, vehicle navigation historical data may be one or more items of data representative of historical avionics data and/or historical external data. Said differently, vehicle navigation historical data may be one or more items of data representative of vehicle operational data that was identify during previous operations of the vehicle 110 and/or other vehicles. In this regard, for example, training the vehicle navigation prediction model at least in part enables the vehicle navigation prediction model to generate navigational performance prediction data. For example, when the navigational performance prediction data includes an indication that a global positioning system (GPS) sensor component of the vehicle 110 is affected by a fault and/or is predicted to be affected by a fault, this may be based at least in part on the vehicle navigation prediction model being trained using vehicle navigation historical data that indicates that other vehicles with a similar type of sensor component have been affected by a similar sensor fault.

In some embodiments, the vehicle navigation support apparatus (e.g., the mobile vehicle navigation support apparatus 120, the onboard vehicle navigation support apparatus 150, and/or the remote vehicle navigation support apparatus 140) may be configured to train the vehicle navigation prediction model when the vehicle 110 is offline. In some embodiments, for example, the vehicle 110 may be offline when the vehicle is not operating. For example, the vehicle 110 may be offline when the vehicle is parked (e.g., at a gate), plugged into an external power supply, turned off, in a maintenance period, and/or the like. Additionally, or alternatively, for example, the vehicle 110 may be offline when the vehicle 110 is not connected to one or more external computing devices (e.g., the remote vehicle navigation support apparatus 140) and/or external data sources that are configured to train the vehicle navigation prediction model. For example, the remote vehicle navigation support apparatus 140 may be configured to train the vehicle navigation prediction model when the vehicle 110 is operating and not connected to the remote vehicle navigation support apparatus 140 (e.g., when the vehicle 110 is in flight).

### Example Methods

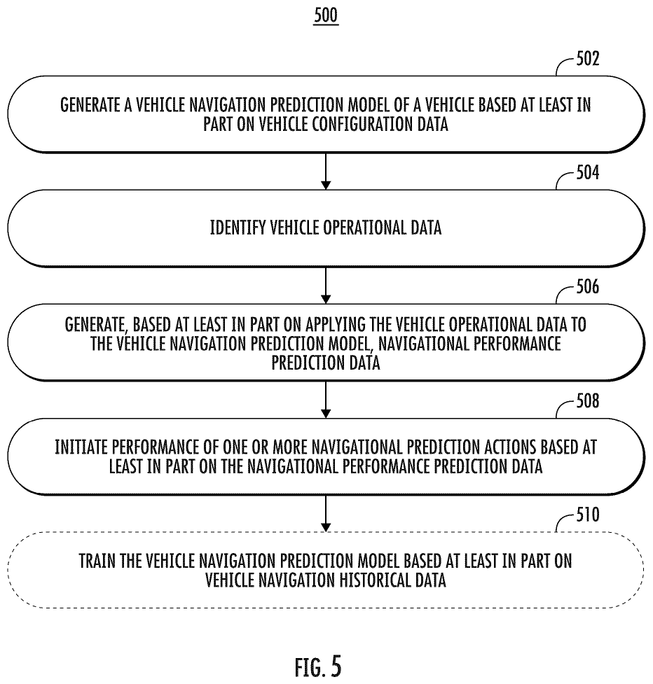

Referring now to FIG. 5, a flowchart providing an example method 500 is illustrated. In this regard, FIG. 5 illustrates operations that may be performed by the vehicle navigation support apparatus (e.g., the mobile vehicle navigation support apparatus 120, the onboard vehicle navigation support apparatus 150, and/or the remote vehicle navigation support apparatus 140), the vehicle 110, and/or the like. In some embodiments, the example method 500 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 500.

As shown in block 502, the method may include generating a vehicle navigation prediction model of a vehicle based at least in part on vehicle configuration data. As described above, in some embodiments, the vehicle navigation prediction model may be a data entity that describes parameters, hyper-parameters, and/or defined operations of a rules-based, machine learning model, and/or generative artificial intelligence model (e.g., a model including at least one of one or more rule-based layers, one or more layers that depend on trained parameters, coefficients, and/or the like). The vehicle navigation prediction model may utilize one or more of any type of machine learning, rules-based, and/or artificial intelligence techniques including one or more of supervised learning, unsupervised learning, semi-supervised learning, reinforcement learning, computer vision techniques, sequence modeling techniques, language processing techniques, neural network techniques, and/or generative artificial intelligence techniques.

Additionally, or alternatively, the vehicle navigation prediction model may be a computer model representation of the vehicle based at least in part on the vehicle configuration data. In this regard, for example, the vehicle navigation prediction model may include one or more computer model representations of one or more of the individual components of the vehicle. For example, the vehicle navigation prediction model may include one or more computer model representations of one or more multi-function control and display unit (MCDU) components, flight management system (FMS) components, sensor components, actuator components, primary flight display (PFD) components, navigation components (e.g., inertial reference system (IRS) components, global positioning system (GPS) components, and/or the like), radio components (e.g., global positioning system (GPS) radio components), and/or the like.

In some embodiments, the vehicle navigation prediction model of the vehicle may be generated by the mobile vehicle navigation support apparatus (e.g., when the vehicle navigation support apparatus is the mobile vehicle navigation support apparatus). In this regard, the vehicle navigation prediction model of the vehicle may be stored in the mobile vehicle navigation support apparatus. In this regard, the vehicle navigation prediction model of the vehicle may be generated and/or stored by an electronic flight bag (e.g., when the mobile vehicle navigation support apparatus is an electronic flight bag).

In some embodiments, the vehicle navigation prediction model may be generated by the onboard vehicle navigation support apparatus (e.g., when the vehicle navigation support apparatus is the onboard vehicle navigation support apparatus). In this regard, the vehicle navigation prediction model may be stored in the onboard vehicle navigation support apparatus. In some embodiments, the vehicle navigation prediction model may be generated by the remote vehicle navigation support apparatus (e.g., when the vehicle navigation support apparatus is the remote vehicle navigation support apparatus). In this regard, the vehicle navigation prediction model may be stored in the remote vehicle navigation support apparatus.

As shown in block 504, the method may include identifying vehicle operational data. As described above, in some embodiments, vehicle operational data may be representative of operations of the vehicle when the vehicle is operating. In some embodiments, for example, the vehicle may be operating when the vehicle is taxiing, in flight (e.g., an aircraft cruising at altitude), during an aircraft approach sequence, taking off, driving down a highway, and/or the like.

In some embodiments, the vehicle navigation support apparatus (e.g., the mobile vehicle navigation support apparatus, the onboard vehicle navigation support apparatus, and/or the remote vehicle navigation support apparatus) may be configured to identify vehicle operational data by capturing it from one or more of the components of the vehicle. In this regard, for example, the vehicle navigation support apparatus (e.g., the mobile vehicle navigation support apparatus, the onboard vehicle navigation support apparatus, and/or the remote vehicle navigation support apparatus) may be configured to capture vehicle operational data from one or more of one or more multi-function control and display unit (MCDU) components, flight management system (FMS) components, sensor components, actuator components, primary flight display (PFD) components, navigation components (e.g., inertial reference system (IRS) components, global positioning system (GPS) components, and/or the like), radio components (e.g., global positioning system (GPS) radio components), and/or the like.

In some embodiments, the vehicle operational data may include avionics data. In some embodiments, the avionics data may be one or more items of data representative of the avionics of the vehicle. In this regard, for example, the avionics data may include one or more items of data representative of an aircraft approach sequence of the vehicle (e.g., when the vehicle is an aircraft, an aircraft approach sequence that the aircraft is performing to land the aircraft at an airport). As another example, the avionics data may include one or more items of data representative of a required navigational performance (RNP) of the vehicle. As another example, the avionics data may include one or more items of data representative of predictive receiver autonomous integrity monitoring (PRAIM). As another example, the avionics data may include one or more items of data representative of one or more sensor faults associated with the vehicle (e.g., with one or more of the one or more sensor components of the vehicle). As another example, the avionics data may include one or more items of data representative of one or more selected sensors associated with the vehicle (e.g., one or more selected sensors of the one or more sensor components of the vehicle). As another example, the avionics data may include one or more items of data representative of sensor drift of one or more of the one or more sensor components of the vehicle. As another example, the avionics data may include one or more items of data representative of sensor stability of one or more of the one or more sensor components of the vehicle 110 (e.g., data representative of data (e.g., position data) provided by a sensor compared to previous data (e.g., previous position data) provided by the sensor).

In some embodiments, the avionics data may be provided, captured, and/or generated at least in part by an operator of the vehicle (e.g., a pilot). Additionally, or alternatively, avionics data may be provided, captured, and/or generated at least in part by another individual associated with the vehicle (e.g., an air traffic controller). Additionally, or alternatively, the avionics data may be provided, captured, and/or generated at least in part by one or more components of the vehicle. In this regard, for example, the avionics data may be provided, captured, and/or generated at least in part by one or more of one or more multi-function control and display unit (MCDU) components, flight management system (FMS) components, sensor components, actuator components, primary flight display (PFD) components, navigation components (e.g., inertial reference system (IRS) components, global positioning system (GPS) components, and/or the like), radio components (e.g., global positioning system (GPS) radio components), and/or the like.

In some embodiments, the vehicle operational data may include external data. In some embodiments, the external data may be one or more items of data representative of external factors that may impact the vehicle. In this regard, for example, the external data may include one or more items of data representative of information associated with a global navigation satellite system (GNSS) (e.g., global positioning system (GPS) coordinates). As another example, the external data may include one or more items of data representative of information associated with a notice to air missions (NOTAM). As another example, the external data may include one or more items of data representative of information associated with a non-directional radio beacon (NDB). As another example, the external data may include one or more items of data representative of weather information for areas proximate to the vehicle (e.g., a thunderstorm is present at an airport where the vehicle intends to perform an aircraft approach sequence to land at).

In some embodiments, the external data may be provided, captured, and/or generated at least in part by one or more external systems (e.g., a system external to the vehicle). For example, the external data may be provided, captured, and/or generated at least in part by a global positioning system (GPS). As another example, the external data may be provided, captured, and/or generated at least in part by an aviation authority (e.g., the Federal Aviation Administration (FAA)). As another example, the external data may be provided, captured, and/or generated at least in part by one or more other vehicles (e.g., an aircraft in proximity to the vehicle).

As shown in block 506, the method may include generating, based at least in part on applying the vehicle operational data to the vehicle navigation prediction model, navigational performance prediction data. As described above, in some embodiments, navigational performance prediction data may be one or more items of data representative of a predicted navigational pathway of the vehicle. In this regard, a predicted navigational pathway of the vehicle may include a predicted pathway that the vehicle may take based at least in part on the current operation of the vehicle (e.g., based at least in part on the avionics data and/or the external data as applied to the vehicle navigation prediction model). For example, a predicted navigational pathway of the vehicle may be a predicted pathway that the vehicle may take during the final portion of an aircraft approach sequence.

In some embodiments, the navigational performance prediction data may be one or more items of data representative of a predicted navigational adherence of the vehicle. In this regard, a predicted navigational adherence of the vehicle may include a prediction of whether the vehicle will adhere to a desired or selected pathway (e.g., based at least in part on the avionics data and/or the external data as applied to the vehicle navigation prediction model). For example, a predicted navigational adherence of the vehicle may be a prediction of whether the vehicle will be within a particular altitude range at a particular point in an aircraft approach sequence. Additionally, or alternatively, a predicted navigational adherence of the vehicle may be a prediction of whether the vehicle will adhere to a required navigational performance (RNP).

In some embodiments, the navigational performance prediction data may be one or more items of data representative of a sensor fault associated with the vehicle. In this regard, the navigational performance prediction data may include an indication whether one or more of the one or more sensor components of the vehicle is affected by a fault and/or is predicted to be affected by a fault (e.g., based at least in part on the avionics data and/or the external data as applied to the vehicle navigation prediction model). For example, the navigational performance prediction data may include an indication that a global positioning system (GPS) sensor component of the vehicle is affected by a fault and/or is predicted to be affected by a fault and, in some embodiments, that the operator of the vehicle should not rely on global positioning system (GPS) coordinates that the vehicle is providing to the operator of the vehicle.

In some embodiments, the navigational performance prediction data may be one or more items of data representative of a predicted weather forecast associated with the vehicle. In this regard, the navigational performance prediction data may include an indication of a weather forecast in an area where the vehicle is transiting towards that may impact the navigation of the vehicle. For example, the navigational performance prediction data may include an indication of a weather forecast at an airport where the vehicle intends to perform an aircraft approach sequence.

As shown in block 508, the method may include initiating performance of one or more navigational prediction actions based at least in part on the navigational performance prediction data. As described above, in some embodiments, a navigational prediction action may include generating and/or transmitting an alert and/or message based at least in part on the navigational performance prediction data. In this regard, in some embodiments, the vehicle navigation support apparatus (e.g., the mobile vehicle navigation support apparatus, the onboard vehicle navigation support apparatus, and/or the remote vehicle navigation support apparatus) may be configured to initiate performance of one or more navigational prediction actions by generating an alert and/or message for and/or transmitting an alert and/or message to an operator of the vehicle (e.g., a pilot) based at least in part on the navigational performance prediction data. For example, the vehicle navigation support apparatus (e.g., the mobile vehicle navigation support apparatus, the onboard vehicle navigation support apparatus, and/or the remote vehicle navigation support apparatus) may be configured to initiate performance of one or more navigational prediction actions by generating an alert and/or message for and/or transmitting an alert and/or message to an operator of the vehicle that indicates that vehicle will not be able to perform its intended aircraft approach sequence (e.g., the navigational performance prediction data indicates that it will be impossible for the vehicle to adhere to the required navigational performance (RNP) for the intended aircraft approach sequence).

In some embodiments, vehicle navigation support apparatus (e.g., the mobile vehicle navigation support apparatus, the onboard vehicle navigation support apparatus, and/or the remote vehicle navigation support apparatus) may be configured to initiate performance of one or more navigational prediction actions by generating an alert and/or message for and/or transmitting an alert and/or message to another individual associated with the vehicle (e.g., an air traffic controller) based at least in part on the navigational performance prediction data. For example, the vehicle navigation support apparatus (e.g., the mobile vehicle navigation support apparatus, the onboard vehicle navigation support apparatus, and/or the remote vehicle navigation support apparatus) may be configured to initiate performance of one or more navigational prediction actions by generating an alert and/or message for and/or transmitting an alert and/or message to another individual associated with the vehicle that indicates that vehicle will not be able to perform its intended aircraft approach sequence (e.g., the navigational performance prediction data indicates that it will be impossible for the vehicle to adhere to the required navigational performance (RNP) for the intended aircraft approach sequence and, in some embodiments, that the vehicle should perform a go around). In this regard, another individual associated with the vehicle may make adjustments based at least in part on the alert and/or message (e.g., schedule another aircraft for a particular landing slot at an airport if the vehicle performs a go around).

In some embodiments, vehicle navigation support apparatus (e.g., the mobile vehicle navigation support apparatus, the onboard vehicle navigation support apparatus, and/or the remote vehicle navigation support apparatus) may be configured to initiate performance of one or more navigational prediction actions by generating an alert and/or message for and/or transmitting an alert and/or message to a maintenance system associated with the vehicle based at least in part on the navigational performance prediction data. For example, the vehicle navigation support apparatus (e.g., the mobile vehicle navigation support apparatus, the onboard vehicle navigation support apparatus, and/or the remote vehicle navigation support apparatus) may be configured to initiate performance of one or more navigational prediction actions by generating an alert and/or message for and/or transmitting an alert and/or message to a maintenance system associated with the vehicle that indicates that vehicle is affected by a sensor fault and, in some embodiments, that a sensor component of the vehicle needs to be replaced after the vehicle completes an aircraft approach sequence.

In some embodiments, a navigational prediction action may include causing actuation of a component of the vehicle based at least in part on the navigational performance prediction data. For example, if the vehicle is affected by a sensor fault, the vehicle navigation support apparatus (e.g., the mobile vehicle navigation support apparatus, the onboard vehicle navigation support apparatus, and/or the remote vehicle navigation support apparatus) may be configured to initiate performance of one or more navigational prediction actions by causing actuation of a sensor component of the vehicle such that the sensor component is reset. As another example, if a predicted navigational pathway of the vehicle indicates that the vehicle will not adhere to the required navigational performance of the vehicle, the vehicle navigation support apparatus (e.g., the mobile vehicle navigation support apparatus, the onboard vehicle navigation support apparatus, and/or the remote vehicle navigation support apparatus) may be configured to initiate performance of one or more navigational prediction actions by causing actuation of a flight management system (FMS) component of the vehicle such that the heading of the vehicle is adjusted.

In some embodiments, a navigational prediction action may include generating one or more navigational prediction interface components. In this regard, the vehicle navigation support apparatus (e.g., the mobile vehicle navigation support apparatus, the onboard vehicle navigation support apparatus, and/or the remote vehicle navigation support apparatus) may be configured to initiate performance of one or more navigational prediction actions by generating one or more navigational prediction interface components.

In some embodiments, for example, the vehicle navigation support apparatus (e.g., the mobile vehicle navigation support apparatus, the onboard vehicle navigation support apparatus, and/or the remote vehicle navigation support apparatus) may be configured to initiate performance of one or more navigational prediction actions by generating a first navigational prediction interface component. In some embodiments, the first navigational prediction interface component may include one or more first predicted navigational adherence visualizations. For example, the first navigational prediction interface component may include an adequate navigational adherence visualization, a marginal navigational adherence visualization, and/or a violation navigational adherence visualization. In some embodiments, each of the first predicted navigational adherence visualizations may be represented graphically, by shading, by color, by text, by numbers, and/or the like. In some embodiments, the vehicle navigation support apparatus (e.g., the mobile vehicle navigation support apparatus, the onboard vehicle navigation support apparatus, and/or the remote vehicle navigation support apparatus) may be configured to cause the first navigational prediction interface component to be rendered on a first navigational interface.

In some embodiments, each of the one or more first predicted navigational adherence visualizations may be associated with a corresponding physical location. For example, the adequate navigational adherence visualization may be associated with a first physical location. As another example, the marginal navigational adherence visualization may be associated with a second physical location. As another example, the violation navigational adherence visualization may be associated with a third physical location.

In some embodiments, each of the one or more first predicted navigational adherence visualizations may be associated with a corresponding predicted navigational adherence. In this regard, for example, the adequate navigational adherence visualization may be associated with an adequate predicted navigational adherence (e.g., the vehicle will adhere to a required navigational performance (RNP) when the vehicle is located in the physical location corresponding to the adequate navigational adherence visualization). As another example, the marginal navigational adherence visualization may be associated with a marginal predicted navigational adherence (e.g., it is marginal that the vehicle will adhere to a required navigational performance (RNP) when the vehicle is located in the physical location corresponding to the marginal navigational adherence visualization). As another example, the violation navigational adherence visualization may be associated with a violation predicted navigational adherence (e.g., the vehicle will not adhere to a required navigational performance (RNP) when the vehicle is located in the physical location corresponding to the violation navigational adherence visualization).

In some embodiments, for example, the vehicle navigation support apparatus (e.g., the mobile vehicle navigation support apparatus, the onboard vehicle navigation support apparatus, and/or the remote vehicle navigation support apparatus) may be configured to initiate performance of one or more navigational prediction actions by generating a second navigational prediction interface component. In some embodiments, the second navigational prediction interface component may include one or more second predicted navigational adherence visualizations. For example, the second navigational prediction interface component may include an acceptable navigational adherence visualization and/or an unacceptable navigational adherence visualization. In some embodiments, each of the second predicted navigational adherence visualizations may be represented graphically, by shading, by color, by text, by numbers, and/or the like. In some embodiments, the vehicle navigation support apparatus (e.g., the mobile vehicle navigation support apparatus, the onboard vehicle navigation support apparatus, and/or the remote vehicle navigation support apparatus) may be configured to cause the second navigational prediction interface component to be rendered on a second navigational interface.

In some embodiments, each of the one or more second predicted navigational adherence visualizations may be associated with a corresponding predicted navigational adherence. In this regard, for example, the acceptable navigational adherence visualization may be associated with an acceptable predicted navigational adherence (e.g., the vehicle will be able to adhere to a particular required navigational performance (RNP)). As another example, the unacceptable navigational adherence visualization may be associated with an unacceptable predicted navigational adherence (e.g., the vehicle will not be able to adhere to a particular required navigational performance (RNP)).

As shown in block 510, the method may optionally include training the vehicle navigation prediction model based at least in part on vehicle navigation historical data. As described above, in some embodiments, vehicle navigation historical data may be one or more items of data representative of historical vehicle operational data. In this regard, vehicle navigation historical data may be one or more items of data representative of historical avionics data and/or historical external data. Said differently, vehicle navigation historical data may be one or more items of data representative of vehicle operational data that was identify during previous operations of the vehicle and/or other vehicles. In this regard, for example, training the vehicle navigation prediction model at least in part enables the vehicle navigation prediction model to generate navigational performance prediction data. For example, when the navigational performance prediction data includes an indication that a global positioning system (GPS) sensor component of the vehicle is affected by a fault and/or is predicted to be affected by a fault, this may be based at least in part on the vehicle navigation prediction model being trained using vehicle navigation historical data that indicates that other vehicles with a similar type of sensor component have been affected by a similar sensor fault.

In some embodiments, the vehicle navigation support apparatus (e.g., the mobile vehicle navigation support apparatus, the onboard vehicle navigation support apparatus, and/or the remote vehicle navigation support apparatus) may be configured to train the vehicle navigation prediction model when the vehicle is offline. In some embodiments, for example, the vehicle 110 may be offline when the vehicle is not operating. For example, the vehicle 110 may be offline when the vehicle is parked (e.g., at a gate), plugged into an external power supply, turned off, in a maintenance period, and/or the like. Additionally, or alternatively, for example, the vehicle 110 may be offline when the vehicle 110 is not connected to one or more external computing devices (e.g., the remote vehicle navigation support apparatus 140) and/or external data sources that are configured to train the vehicle navigation prediction model. For example, the remote vehicle navigation support apparatus 140 may be configured to train the vehicle navigation prediction model when the vehicle 110 is operating and not connected to the remote vehicle navigation support apparatus 140 (e.g., when the vehicle 110 is in flight).

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this specification contains many specific embodiment and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

That which is claimed:

1. A method comprising:
generating a vehicle navigation prediction model of a vehicle based at least in part on vehicle configuration data;
identifying vehicle operational data, wherein the vehicle operational data is representative of operations of the vehicle when the vehicle is operating;
generating, based at least in part on applying the vehicle operational data to the vehicle navigation prediction model, navigational performance prediction data; and
initiating performance of one or more navigational prediction actions based at least in part on the navigational performance prediction data.

2. The method of claim 1, further comprising:
training the vehicle navigation prediction model based at least in part on vehicle navigation historical data.

3. The method of claim 2, wherein training the vehicle navigation prediction model occurs when the vehicle is offline.

4. The method of claim 1, wherein the vehicle is an aircraft.

5. The method of claim 1, wherein the vehicle navigation prediction model is generated by a mobile vehicle navigation support apparatus.

6. The method of claim 5, wherein the mobile vehicle navigation support apparatus is an electronic flight bag.

7. The method of claim 1, wherein the vehicle navigation prediction model is generated by an onboard vehicle navigation support apparatus.

8. The method of claim 1, wherein the vehicle navigation prediction model is generated by a remote vehicle navigation support apparatus.

9. The method of claim 1, wherein the vehicle navigation prediction model comprises a machine learning model.

10. The method of claim 1, wherein the vehicle operational data comprises avionics data and external data.

11. The method of claim 10, wherein the avionics data indicates that the vehicle is performing an aircraft approach sequence.

12. The method of claim 1, wherein initiating performance of one or more navigational prediction actions comprises:
generating a navigational prediction interface component.

13. The method of claim 12, wherein the navigational prediction interface component comprises one or more predicted navigational adherence visualizations, wherein each of the one or more predicted navigational adherence visualizations is associated with a corresponding physical location.

14. An apparatus comprising at least one processor and at least one non-transitory memory including computer-coded instructions thereon, the computer coded instructions, with the at least one processor, cause the apparatus to:
generate a vehicle navigation prediction model of a vehicle based at least in part on vehicle configuration data;
identify vehicle operational data, wherein the vehicle operational data is representative of operations of the vehicle when the vehicle is operating;
generate, based at least in part on applying the vehicle operational data to the vehicle navigation prediction model, navigational performance prediction data; and
initiate performance of one or more navigational prediction actions based at least in part on the navigational performance prediction data.

15. The apparatus of claim 14, wherein the computer coded instructions, further with the at least one processor, cause the apparatus to:
train the vehicle navigation prediction model based at least in part on vehicle navigation historical data.

16. The apparatus of claim 15, wherein training the vehicle navigation prediction model occurs when the vehicle is offline.

17. The apparatus of claim 14, wherein the vehicle is an aircraft.

18. The apparatus of claim 14, wherein the vehicle navigation prediction model is generated by a mobile vehicle navigation support apparatus, wherein the mobile vehicle navigation support apparatus is an electronic flight bag.

19. The apparatus of claim 14, wherein initiating performance of one or more navigational prediction actions comprises generating a navigational prediction interface, wherein the navigational prediction interface comprises one or more predicted navigational adherence visualizations, wherein each of the one or more predicted navigational adherence visualizations is associated with a corresponding physical location.

20. A computer program product comprising at least one non-transitory computer-readable storage medium having computer program code stored thereon that, in execution with at least one processor, configures the computer program product for:
generating a vehicle navigation prediction model of a vehicle based at least in part on vehicle configuration data;
identifying vehicle operational data, wherein the vehicle operational data is representative of operations of the vehicle when the vehicle is operating;
generating, based at least in part on applying the vehicle operational data to the vehicle navigation prediction model, navigational performance prediction data; and
initiating performance of one or more navigational prediction actions based at least in part on the navigational performance prediction data.
